(19) United States
(12) Patent Application Publication
(10) Pub. No.: US 2026/0006332 A1
(43) Pub. Date: Jan. 1, 2026

(54) ELECTRONIC DEVICE AND ZOOMING PHOTOGRAPHY METHOD THEREOF

(71) Applicant: ASUSTeK COMPUTER INC., Taipei City (TW)

(72) Inventor: Chang-Tai Lee, Taipei City (TW)

(73) Assignee: ASUSTeK COMPUTER INC., Taipei City (TW)

(21) Appl. No.: 19/200,662

(22) Filed: May 7, 2025

(30) Foreign Application Priority Data
Jun. 28, 2024 (TW) 113124258

(51) Int. Cl. H04N 23/69

(52) U.S. Cl. CPC H04N 23/69

(57) ABSTRACT

An electronic device and a zooming photography method thereof are provided. The method is adapted to the electronic device including an image sensor and includes the following steps. The image sensor is controlled to generate multiple first preview images according to a zoom scaling factor during a period of operating in a preview mode. The first preview images are copied to a buffer. Multiple second preview images are extracted from the first preview images in the buffer when receiving a photographing command. A final photographed image conforming to an image storage format is generated according to the second preview images based on the zoom scaling factor.

### CROSS-REFERENCE TO RELATED APPLICATION

This application claims the priority benefit of Taiwan application serial no. 113124258, filed on Jun. 28, 2024. The entirety of the above-mentioned patent application is hereby incorporated by reference herein and made a part of this specification.

### BACKGROUND

### Technical Field

The disclosure relates to a zooming photography method and an electronic device using the method.

### Description of Related Art

With the advancement of technology, electronic apparatuses with image capturing functions have become prevalent in modern lives of people. Through adjusting various shooting parameters, images with different image effects may be obtained. For example, shutter speed, exposure time, sensitivity (ISO), scaling factor, etc., are all important shooting parameters that may affect shooting results. Currently, in order to improve preview smoothness, many camera devices shorten the exposure time in preview modes in conjunction with higher sensitivity to achieve suitable exposure levels. When the user issues a photographing command, the camera goes through the exposure procedure again to determine the appropriate exposure time and sensitivity. However, the overall photographing time is extended due to the re-exposure of the photosensitive element and the re-determination of the shooting parameters, which brings a poor experience to the user. On the other hand, as the number of pixels in the photosensitive element increases, digital zoom is also gradually being used in a wider range of applications. However, how to improve the image quality after digital zoom is also an issue that needs to be solved.

### SUMMARY

The disclosure provides a zooming photography method, which is adapted to an electronic device including an image sensor. The method includes the following steps. The image sensor is controlled to generate multiple first preview images according to a zoom scaling factor during a period of operating in a preview mode. The first preview images are copied to a buffer. Multiple second preview images are extracted from the first preview images in the buffer when receiving a photographing command. A final photographed image conforming to an image storage format is generated according to the second preview images based on the zoom scaling factor.

The disclosure also provides an electronic device, which includes an image sensor and a processor. The processor is coupled to the image sensor. The processor is configured to execute the following operations. The image sensor is controlled to generate multiple first preview images according to a zoom scaling factor during a period of operating in a preview mode. The first preview images are copied to a buffer. Multiple second preview images are extracted from the first preview images in the buffer when receiving a photographing command. A final photographed image conforming to an image storage format is generated according to the second preview images based on the zoom scaling factor.

Based on the above, in the embodiments of the disclosure, the image sensor generates the first preview images based on the zoom scaling factor in the preview mode, and the first preview images are recorded in the buffer. When receiving the photographing command, the final photographed image conforming to the image storage format may be generated according to the preview images recorded in the buffer. Based on this, the operation of reconfiguring the image sensor for exposure in response to a shutter signal may be omitted, thereby speeding up the photographing speed to improve the user experience.

### BRIEF DESCRIPTION OF THE DRAWINGS

FIG. 1 is a block schematic diagram of an electronic device according to an embodiment of the disclosure.

FIG. 2 is a schematic diagram of a camera system software framework according to an embodiment of the disclosure.

FIG. 3 is a flowchart of a zooming photography method according to an embodiment of the disclosure.

FIG. 4A is a schematic diagram of displaying a preview image according to an embodiment of the disclosure.

FIG. 4B is a schematic diagram of generating a final photographed image according to an embodiment of the disclosure.

FIG. 5 is a flowchart of a zooming photography method according to an embodiment of the disclosure.

FIG. 6 is a flowchart of determining an integer scaling factor according to an embodiment of the disclosure.

FIG. 7 is a flowchart of displaying a preview image according to an embodiment of the disclosure.

FIG. 8 is a flowchart of generating a final photographed image according to an embodiment of the disclosure.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to refer to the same or similar parts. The embodiments are only a part of the disclosure and do not disclose all possible implementations of the disclosure. More precisely, the embodiments are merely examples of devices and methods in the claims of the disclosure.

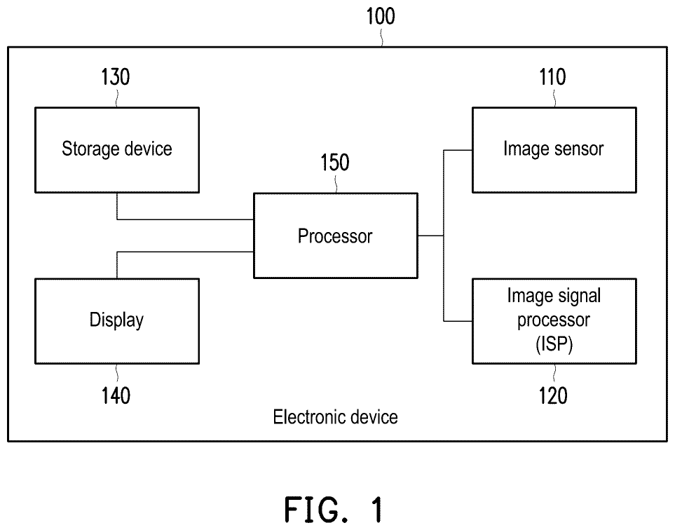

Please refer to FIG. 1. An electronic device 100 may include an image sensor 110, an image signal processor (ISP) 120, a storage device 130, a display 140, and a processor 150. The electronic device 100 may be, for example, a smart phone, a digital camera, a tablet, a game console, an electronic wearable device, a photography device, or other electronic apparatuses with image shooting functions, and the type of the electronic device 100 is not limited thereto.

The image sensor 110 is used to shoot images and may include a lens, an image sensing element, and other components. The lens may include an optical lens for controlling a light path. The image sensing element is used to provide an image sensing function. The image sensing element 112 may include a photosensitive element, such as a charge coupled device (CCD), a complementary metal-oxide semiconductor (CMOS), element or other elements, which is not limited in the disclosure. The lens may focus imaging light rays onto the image sensing element to capture the images.

The image signal processor (ISP) 120 is used to process image data in real time. The image signal processor 120 may obtain raw image data from the image sensor 110 and perform front-end image processing on the raw image data. For example, the image signal processor 120 may perform image optimization processing, such as contrast enhancement, color correction, sharpening, and noise removal, on the raw image data. In some embodiments, the image signal processor 120 may adjust an exposure parameter according to scene light information. In addition, in some embodiments, the image signal processor 120 may perform image synthesis processing on multiple images from the image sensor 110 to improve the dynamic range or the contrast of the images.

The storage device 130 is used to store data such as files, images, commands, program codes, and software modules and may be, for example, any type of fixed or removable random access memory (RAM), read-only memory (ROM), flash memory, hard disk, or other similar devices, an integrated circuit, or a combination thereof.

The display 140 may be a liquid crystal display (LCD), a light emitting diode (LED) display, an organic light emitting diode (OLED), and other types of displays, which is not limited in the disclosure. The display 110 may be used to display a program operation interface, a shooting preview screen, a shooting result screen, etc. of a camera application.

The processor 150 is coupled to the display 140, the image sensor 110, and the storage device 130 and is, for example, a central processing unit (CPU), an application processor (AP), other programmable general-purpose or specific-purpose microprocessors, digital signal processors (DSP), image signal processors (ISP), graphics processing units (GPU), other similar devices, an integrated circuit, or a combination thereof. In some embodiments, the processor 150 may execute commands or program codes in the storage device 130 to implement various steps of a zooming photography method in the embodiment of the disclosure.

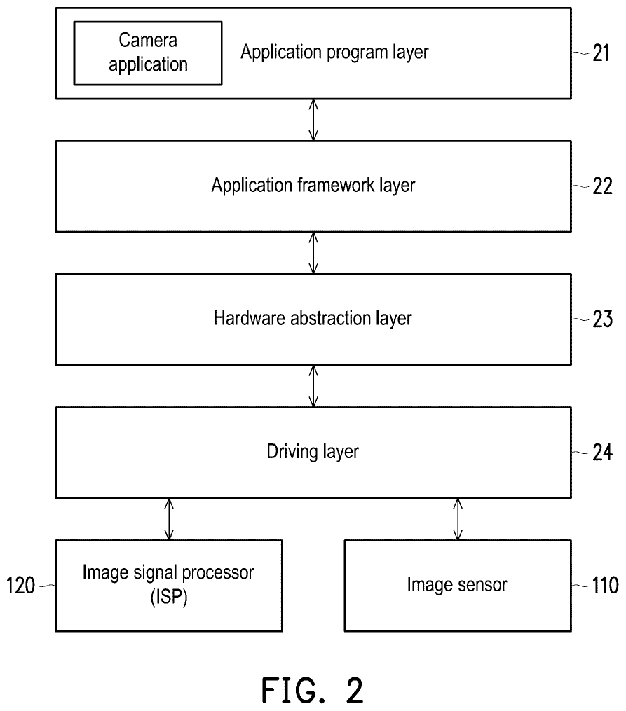

FIG. 2 is a schematic diagram of a camera system software framework according to an embodiment of the disclosure. Please refer to FIG. 2. The camera system software framework of the electronic device 100 may include an application program layer 21, an application framework layer 22, a hardware abstraction layer 23, and a driving layer 24. The application program layer 21 may include a camera application CA1. The camera application CA1 allows a user to use and control camera functions. The camera application CA1 is the main interface for the user to directly interact with the camera system, such as a camera application program of a smartphone. The application framework layer 22 provides an application programming interface (API) for an application in the application program layer 21. For example, the application framework layer 22 may include a camera service module.

The hardware abstraction layer (HAL) 23 provides a standardized interface, allowing the upper application program layer 21 and application framework layer 22 to communicate with different hardware apparatuses without considering details of specific hardware. In some embodiments, the hardware abstraction layer 23 of the camera system (also referred to as a camera hardware abstraction layer (camera HAL)) may perform front-end image processing, digital zoom processing, etc. on the image data from the image signal processor 120 or the image sensor 110. The driving layer 24 may include a driver for underlying hardware (for example, the image sensor 110 and the image signal processor 120). In other words, the hardware abstraction layer 23 may be used to link the API or the service module in the application framework layer 22 with the driver of the driving layer 24.

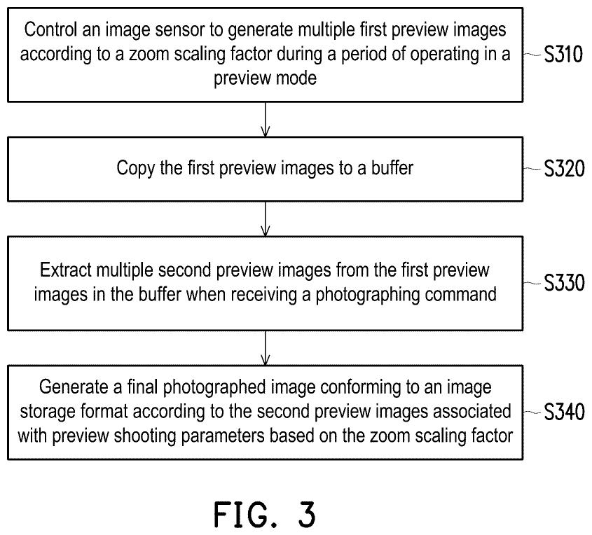

FIG. 3 is a flowchart of a zooming photography method according to an embodiment of the disclosure. Please refer to FIG. 3. The method of the embodiment may be executed by the electronic device 100 of FIG. 1. The details of various steps in FIG. 3 will be described below in conjunction with the elements shown in FIG. 1.

In step S310, the processor 150 controls the image sensor 110 to generate multiple first preview images according to a zoom scaling factor during a period of operating in a preview mode. Specifically, during the period of the preview mode, the image sensor 110 continuously generates the first preview images according to preview shooting parameters, so that the user may determine photographing timing and photographing composition through viewing the preview images. The preview shooting parameters may include a first exposure parameter, a focus parameter, and other shooting parameters. For example, through ambient metering and exposure parameter determination procedures executed during the period of the preview mode, the exposure parameter for generating the first preview images may be determined.

It should be noted that in the embodiment of the disclosure, the image sensor 110 has the ability to output image data with different integer scaling factors. Therefore, the processor 150 may control the image sensor 110 to perform a preliminary zooming operation according to the real-time zoom scaling factor. Specifically, through controlling whether to drive multiple sensing elements of the image sensor 110, a specific sensing element in a sensing array may be selectively enabled or disabled. Therefore, through controlling driving states of the sensing elements of the image sensor 110, the image sensor 110 may output the image data with different integer scaling factors, thereby implementing zoom scaling. Such method can ensure that image quality is not compromised.

In step S320, the processor 150 copies the first preview images to a buffer. The buffer may be used to store the image data generated by the image sensor 110. For example, the buffer may be a zero shutter lag (ZSL) buffer. The processor 150 may continuously record the first preview images into the buffer in the storage device 130. The buffer may record an image sequence in a first-in-first-out manner.

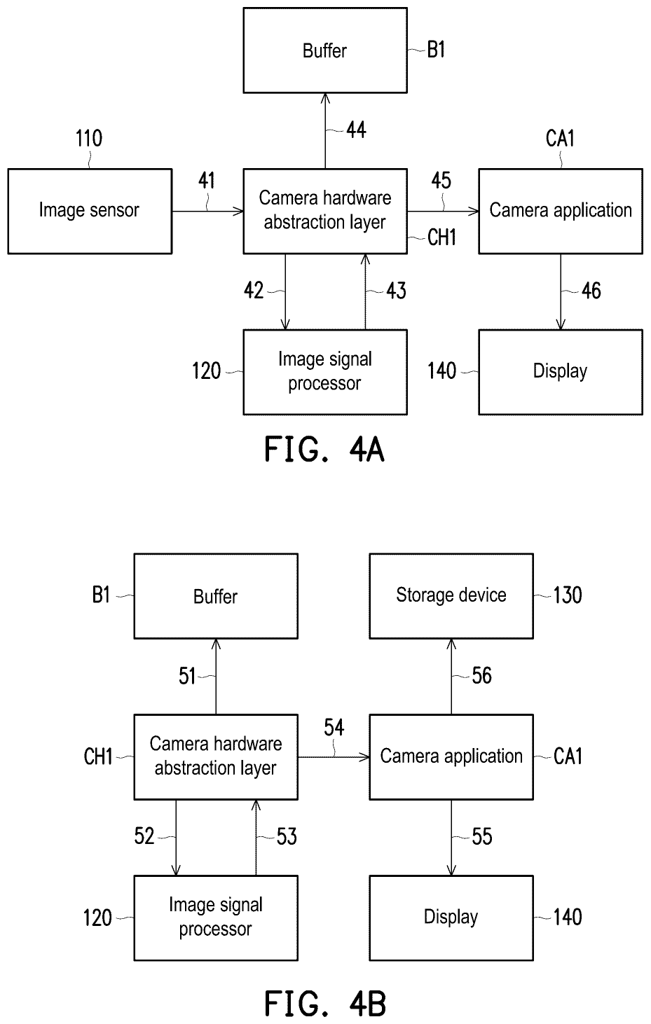

In more detail, FIG. 4A is a schematic diagram of displaying a preview image according to an embodiment of the disclosure. Please refer to FIG. 4A. In operation 41, during the period of the preview mode, the camera hardware abstraction layer CH1 continuously receives the first preview images generated by the image sensor 110. Here, the camera hardware abstraction layer CH1 may set the integer scaling factor of the image sensor 110 according to the zoom scaling factor to control the image sensor 110 to generate the first preview images conforming to the integer scaling factor. For example, when the real-time zoom scaling factor is in a low factor interval (for example, greater than 1 time but less than 2 times), the integer scaling factor of the image sensor 110 is 1 time (that is, an image is not scaled). When the real-time zoom scaling factor is in a high factor interval (for example, greater than 2 times), the integer scaling factor of the image sensor 110 is 2 times.

In operation 42, the camera hardware abstraction layer CH1 transmits the first preview images to the image signal processor 120 for front-end image processing, and generates a YUV preview image in YUV format. In some embodiments, when the real-time zoom scaling factor is in the low factor interval (for example, greater than 1 time but less than 2 times), the camera hardware abstraction layer CH1 may first perform digital zoom processing on the first preview images, and then perform YUV format conversion. In operation 43 and operation 44, the camera hardware abstraction layer CH1 stores the first preview images after front-end image processing into a buffer B1. Based on the above, it can be seen that the buffer B1 may store the first preview image with different integer scaling factors (for example, 1 time, 2 times, etc.) according to the zoom scaling factor for use in a subsequent photography stage.

In operation 45, the camera hardware abstraction layer CH1 transmits the YUV preview image generated by the image signal processor 120 to the camera application CA1. In some embodiments, when the real-time zoom scaling factor is in the high factor interval (for example, greater than 2 times), the camera application CA1 may perform digital zoom processing on the YUV preview image. In operation 46, the display 140 displays a preview screen according to the YUV preview image. In some embodiments, the digital zoom processing includes image cropping processing and image scaling processing.

Please return to FIG. 3. In step S330, the processor 150 extracts multiple second preview images from the first preview images in the buffer when receiving a photographing command. In some embodiments, in response to the processor 150 receiving the photographing command issued by the user, the processor 150 may read the second preview images from the buffer. Specifically, the processor 150 may identify a certain second preview image from the buffer according to the photographing command, and capture the second preview image and the second preview images subsequent to the second preview image. The disclosure does not limit the number of the second preview images. In other words, after the user issues the photographing command, the image sensor 110 may still continuously generate the first preview images, and the processor 150 may also continuously record the first preview images into the buffer.

In step S340, the processor 150 generates a final photographed image conforming to an image storage format according to the second preview images based on the zoom scaling factor. Specifically, since the image sensor 110 may implement digital zoom with the integer scaling factor, the processor 150 may need to perform digital zoom processing again according to a factor difference between the real-time zoom scaling factor and the integer scaling factor. In addition, the processor 150 may synthesize the second preview images into the final photographed image, and compress the final photographed image into the image storage format for storage. For example, the image storage format is, for example, JPEG format, but not limited thereto.

It should be noted that in some embodiments, the processor 150 does not need to control the image sensor 110 to reconfigure the shooting parameters in response to the photographing command. After the user issues the photographing command, the image sensor 110 still generates the first preview images according to the preview shooting parameters, and the processor 150 synthesizes the second preview images among the first preview images into the final photographed image. Therefore, some procedures of resetting the shooting parameters may be omitted and the overall photographing time can be saved.

In more detail, FIG. 4B is a schematic diagram of generating a final photographed image according to an embodiment of the disclosure. Please refer to FIG. 4B. In operation 51, the camera hardware abstraction layer CH1 reads the second preview images from the buffer B1 in response to the photographing command. In operation 52, when the real-time zoom scaling factor is in the low factor interval (for example, greater than 1 time but less than 2 times), the camera hardware abstraction layer CH1 may perform digital zoom processing, image synthesis processing, and YUV format conversion on the second preview images. When the real-time zoom scaling factor is in the high factor interval (for example, greater than 2 times), the camera hardware abstraction layer CH1 may perform front-end image processing and YUV format conversion on the second preview images, but does not execute digital zoom processing and image synthesis processing.

In operation 53 and operation 54, the camera hardware abstraction layer CH1 outputs the image data in YUV format (that is, the second preview images or multiple digital zoom images) to the camera application CA1. When the real-time zoom scaling factor is in the high factor interval (for example, greater than 2 times), the camera application CA1 may perform digital zoom processing, resolution optimization processing, and image synthesis processing on the second preview images in YUV format to generate a synthesized image in YUV format. When the real-time zoom scaling factor is in the low factor interval (for example, less than 2 times), the camera application CA1 may receive the synthesized image in YUV format from the camera hardware abstraction layer CH1. The camera application CA1 may perform back-end image processing on the synthesized image. Back-end image processing executed by the camera application CA1 may be, for example, red-eye removal processing, watermark processing, etc. to generate the final photographed image. In operation 55, the display 140 displays the final photographed image in YUV format. In operation 56, the storage device 130 may store the final photographed image conforming to the image storage format.

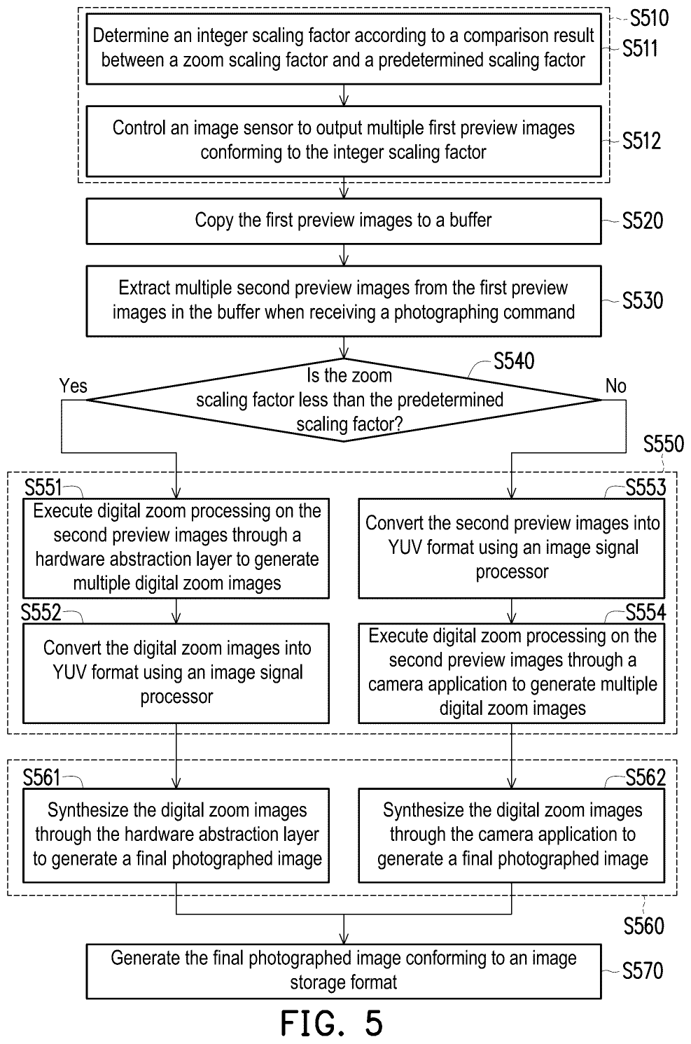

FIG. 5 is a flowchart of a zooming photography method according to an embodiment of the disclosure. Please refer to FIG. 5. The method of the embodiment may be executed by the electronic device 100 of FIG. 1. The details of various steps in FIG. 5 will be described below in conjunction with the elements shown in FIG. 1.

In step S510, during the period of operating in the preview mode, the processor 150 controls the image sensor to generate the first preview images according to the zoom scaling factor. Step S510 may be implemented as step S511 and step S512. In step S511, the processor 150 determines the integer scaling factor according to a comparison result between the zoom scaling factor and a predetermined scaling factor. In detail, the processor 150 compares the zoom scaling factor with the predetermined scaling factor, and judges whether the zoom scaling factor is greater than, equal to, or smaller than the predetermined scaling factor to determine the integer scaling factor. The predetermined scaling factor may be set according to actual requirements.

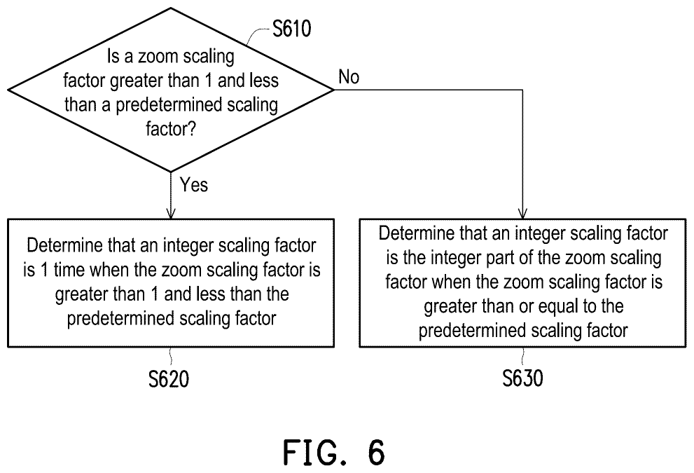

Please refer to FIG. 6. In some embodiments, step S511 may be implemented as step S610 to step S630. In step S610, the processor 150 judges whether the zoom scaling factor is greater than 1 and less than the predetermined scaling factor. That is, the processor 150 judges whether the zoom scaling factor is within the low factor interval. In step S620 (the judgement in step S610 is yes), the processor 150 determines that the integer scaling factor is 1 time when the zoom scaling factor is greater than 1 and less than the predetermined scaling factor. For example, when the zoom scaling factor is 1.2 times, 1.5 times, etc., the integer scaling factor is 1 time. That is, the processor 150 disables a sensing zoom function of the image sensor 110.

In step S630 (the judgement in step S610 is no), the processor 150 determines that the integer scaling factor is the integer part of the zoom scaling factor when the zoom scaling factor is greater than or equal to the predetermined scaling factor, that is, the zoom scaling factor is within the high factor interval. For example, when the zoom scaling factor is 2.5 times, the integer scaling factor is 2 times. When the zoom scaling factor is 3.6 times, the integer scaling factor is 3 times.

In step S512, the processor 150 controls the image sensor 110 to output the first preview images conforming to the integer scaling factor. It can be seen from this that when the user sets the zoom scaling factor to 1.5 times, the first preview images are images with the integer scaling factor of 1 time. When the user sets the zoom scaling factor to 2.5 times, the first preview images are images with the integer scaling factor of 2 times.

In step S520, the processor 150 copies the first preview images to the buffer. In step S530, when receiving the photographing command, the processor 150 extracts the second preview images from the first preview images in the buffer. Reference may be made to the foregoing embodiment for the detailed operations of the steps, which will not be reiterated.

In step S540, the processor 150 judges whether the zoom scaling factor is less than the predetermined scaling factor. In some embodiments, the processor 150 judges whether the zoom scaling factor is between 1 and the predetermined scaling factor. In other embodiments, the processor 150 may judge which factor interval the zoom scaling factor set by the user is in.

In step S550, the processor 150 determines whether to use the hardware abstraction layer or the camera application to execute digital zoom processing on the second preview images according to the comparison result between the zoom scaling factor and the predetermined scaling factor to generate the digital zoom images. In some embodiments, step S550 may be implemented as step S551 to step S554.

In step S551 (the judgement in step S540 is yes), when the zoom scaling factor is greater than 1 and less than the predetermined scaling factor, the processor 150 executes digital zoom processing on the second preview images through the hardware abstraction layer to generate the digital zoom images. For example, assuming that the zoom scaling factor set by the user is 1.5 times, the image signal processor 120 may be set through the hardware abstraction layer to execute 1.5-time digital zoom processing. Afterwards, in step S552, when the zoom scaling factor is greater than 1 and less than the predetermined scaling factor, the processor 150 converts the digital zoom images into YUV format using the image signal processor 120.

On the other hand, in step S553 (the judgement in step S540 is no), when the zoom scaling factor is greater than or equal to the predetermined scaling factor, the processor 150 converts the second preview images into YUV format using the image signal processor 120. Afterwards, in step S554, when the zoom scaling factor is greater than or equal to the predetermined scaling factor, the processor 150 executes digital zoom processing on the second preview images through the camera application to generate the digital zoom images.

In some embodiments, the processor 150 determines a digital zoom factor according to the zoom scaling factor and the integer scaling factor. Then, the processor 150 executes digital zoom processing on the second preview images according to the digital zoom factor through the camera application. For example, assuming that the zoom scaling factor set by the user is 2.5 times, the integer scaling factor of the image sensor 110 is 2 times. In the case where the image sensor 110 has enlarged an image content by 2 times, the processor 150 may determine that the digital zoom factor is 1.25 times. That is, the processor 150 needs to execute 1.25-time digital zoom processing on the second preview images through the camera application.

In some embodiments, the processor 150 executes resolution optimization processing on multiple resulting images with the digital zoom factor through the camera application to generate the digital zoom images. In some embodiments, the processor 150 may perform resolution optimization processing using a super-resolution convolution neural network (SRCNN). Specifically, the processor 150 may execute digital zoom processing on the second preview images according to the digital zoom factor to generate the resulting images, and then perform resolution optimization processing on the resulting images to generate the digital zoom images.

In step S560, the processor 150 synthesizes the digital zoom images to generate the final photographed image. For example, image synthesis processing executed by the processor 150 may synthesize multiple short exposure images into one long exposure image. For example, the second preview images may be the short exposure images corresponding to the preview shooting parameters. The processor 150 may synthesize to form the final photographed image that is the long exposure image according to the second preview images. Alternatively, image synthesis processing executed by the processor 150 may generate a high dynamic range image.

In some embodiments, step S560 may be implemented as step S561 and step S562. In step S561, when the zoom scaling factor is greater than 1 and less than the predetermined scaling factor, the processor 150 synthesizes the digital zoom images through the hardware abstraction layer to generate the final photographed image. In step S562, when the zoom scaling factor is greater than or equal to the predetermined scaling factor, the processor 150 synthesizes the digital zoom images through the camera application to generate the final photographed image. In step S570, the processor 150 generates the final photographed image conforming to the image storage format. It can be seen that during a process of generating the final photographed image, the processor 150 may implement digital zoom processing and image synthesis processing on different software layers according to the zoom scaling factor.

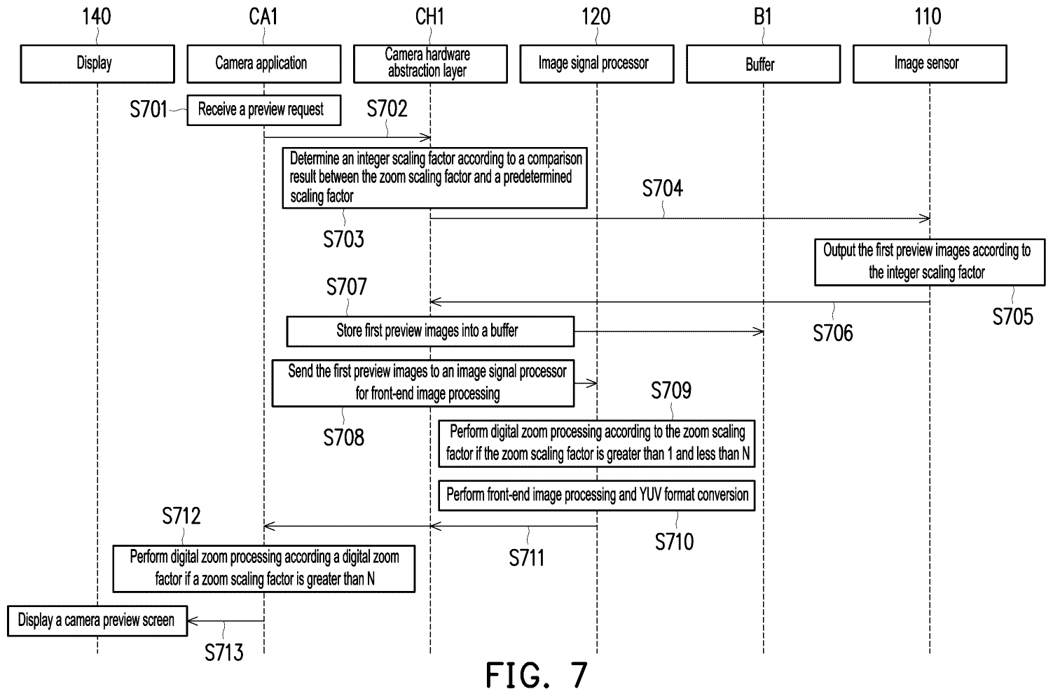

FIG. 7 is a flowchart of displaying a preview image according to an embodiment of the disclosure. Please refer to FIG. 7. In step S701, the camera application CA1 receives a preview request. In step S702, the camera application CA1 may notify the camera hardware abstraction layer CH1 of the zoom scaling factor of the preview request. In step S703, the camera hardware abstraction layer CH1 determines the integer scaling factor according to the comparison result between the zoom scaling factor and the predetermined scaling factor. In step S704, the camera hardware abstraction layer CH1 sends a control signal with the integer scaling factor to the image sensor 110. In step S705, the image sensor 110 continuously outputs the first preview images according to the integer scaling factor. In step S706, the camera hardware abstraction layer CH1 receives the first preview images from the image sensor 110.

In step S707, the camera hardware abstraction layer CH1 stores the first preview images into the buffer B1. The buffer B1 stores the first preview images conforming to the integer scaling factor. In step S708, the camera hardware abstraction layer CH1 sends the first preview images to the image signal processor 120 for front-end image processing. In step S709, the image signal processor 120 performs digital zoom processing according to the zoom scaling factor if the zoom scaling factor is greater than 1 and less than N. In step S710, the image signal processor 120 performs front-end image processing and YUV format conversion to generate the YUV preview image.

In step S711, the camera hardware abstraction layer CH1 receives the YUV preview image from the image signal processor 120, and sends the YUV preview image to the camera application CA1. In step S712, the camera application CA1 performs digital zoom processing according the digital zoom factor if the zoom scaling factor is greater than N. That is, the camera application CA1 performs digital zoom processing on the YUV preview image. In step S713, the display 140 presents a camera preview screen according to the YUV preview image provided by the camera application CA1.

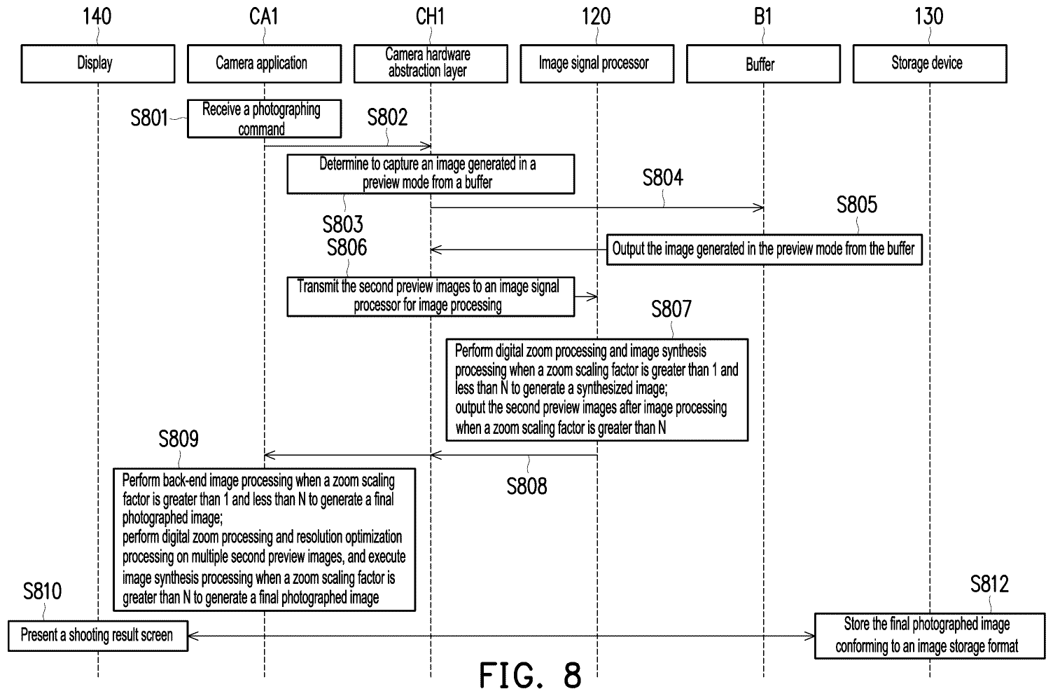

FIG. 8 is a flowchart of generating a final photographed image according to an embodiment of the disclosure. Please refer to FIG. 8. In step S801, the camera application CA1 receives the photographing command issued by the user. In step S802, the camera application CA1 sends the photographing command to the camera hardware abstraction layer CH1. In step S803, the camera hardware abstraction layer CH1 determines to capture an image generated in the preview mode from the buffer B1 in response to the photographing command. In step S804, the camera hardware abstraction layer CH1 sends an image read command to the buffer B1. In step S805, the second preview images are output from the first preview images in the buffer B1. In step S806, the camera hardware abstraction layer CH1 transmits the second preview images to the image signal processor 120 for front-end image processing.

In step S807, the image signal processor 120 performs front-end image processing, digital zoom processing, and image synthesis processing when the zoom scaling factor is greater than 1 and less than the predetermined scaling factor N to generate the synthesized image. The image signal processor 120 does not execute digital zoom processing and image synthesis processing, and outputs the second preview images after front-end image processing when the zoom scaling factor is greater than the predetermined scaling factor N. In addition, the image signal processor 120 may perform YUV format conversion on the synthesized image or the second preview images.

In step S808, the camera hardware abstraction layer CH1 sends the synthesized image or the second preview images after digital zoom to the camera application CA1. In step S809, the camera application CA1 performs back-end image processing on the synthesized image when the zoom scaling factor is greater than 1 and less than N to generate the final photographed image. The camera application CA1 performs digital zoom processing and resolution optimization processing on the second preview images, and executes image synthesis processing and back-end image processing when the zoom scaling factor is greater than N to generate the final photographed image. In step S810, the display 140 presents the shooting result screen according to the final photographed image provided by the camera application CA1. In step S812, the storage device 130 stores the final photographed image conforming to the image storage format.

In summary, in the embodiments of the disclosure, the image sensor is set to generate the first preview images according to the integer scaling factor in the preview mode, and the first preview images conforming to the integer scaling factor are recorded into the buffer. When receiving the photographing command, the final photographed image conforming to the image storage format may be generated according to the preview images recorded in the buffer. Based on this, the operation of reconfiguring the image sensor for exposure in response to a shutter signal may be omitted, thereby speeding up the photographing speed to improve the user experience. In addition, digital zoom processing and image synthesis processing may be performed on different software architecture levels according to the zoom scaling factor set by the user, so as to achieve a what you see is what you get (WYSIWYG) photography experience and a good photography image quality.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A zooming photography method, adapted to an electronic device comprising an image sensor, the zooming photography method comprising:
controlling the image sensor to generate a plurality of first preview images according to a zoom scaling factor during a period of operating in a preview mode;
copying the first preview images to a buffer;
extracting a plurality of second preview images from the first preview images in the buffer when receiving a photographing command; and
generating a final photographed image conforming to an image storage format according to the second preview images based on the zoom scaling factor.

2. The zooming photography method according to claim 1, wherein the step of controlling the image sensor to generate the first preview images according to the zoom scaling factor during the period of operating in the preview mode comprises:
determining an integer scaling factor according to a comparison result between the zoom scaling factor and a predetermined scaling factor; and
controlling the image sensor to output the first preview images conforming to the integer scaling factor.

3. The zooming photography method according to claim 2, wherein the step of determining the integer scaling factor according to the comparison result between the zoom scaling factor and the predetermined scaling factor comprises:
determining that the integer scaling factor is 1 time when the zoom scaling factor is greater than 1 and less than the predetermined scaling factor; and
determining that the integer scaling factor is an integer part of the zoom scaling factor when the zoom scaling factor is greater than or equal to the predetermined scaling factor.

4. The zooming photography method according to claim 2, wherein the step of generating the final photographed image conforming to the image storage format according to the second preview images based on the zoom scaling factor comprises:
determining whether to use a hardware abstraction layer or a camera application to execute digital zoom processing on the second preview images according to the comparison result between the zoom scaling factor and the predetermined scaling factor to generate a plurality of digital zoom images; and
synthesizing the digital zoom images to generate the final photographed image.

5. The zooming photography method according to claim 4, wherein the step of determining whether to use the hardware abstraction layer or the camera application to execute the digital zoom processing on the second preview images according to the comparison result between the zoom scaling factor and the predetermined scaling factor to generate the digital zoom images comprises:
executing the digital zoom processing on the second preview images through the hardware abstraction layer when the zoom scaling factor is greater than 1 and less than the predetermined scaling factor to generate the digital zoom images; and
executing the digital zoom processing on the second preview images through the camera application when the zoom scaling factor is greater than or equal to the predetermined scaling factor to generate the digital zoom images.

6. The zooming photography method according to claim 5, wherein the step of executing the digital zoom processing on the second preview images through the camera application to generate the digital zoom images comprises:
determining a digital zoom factor according to the zoom scaling factor and the integer scaling factor; and
executing the digital zoom processing on the second preview images according to the digital zoom factor through the camera application; and
executing resolution optimization processing on a plurality of resulting images with the digital zoom factor through the camera application to generate the digital zoom images.

7. The zooming photography method according to claim 5, wherein the step of determining whether to use the hardware abstraction layer or the camera application to execute the digital zoom processing on the second preview images according to the comparison result between the zoom scaling factor and the predetermined scaling factor to generate the digital zoom images comprises:
converting the second preview images into YUV format using an image signal processor when the zoom scaling factor is greater than or equal to the predetermined scaling factor.

8. The zooming photography method according to claim 5, wherein the step of determining whether to use the hardware abstraction layer or the camera application to execute the digital zoom processing on the second preview images according to the comparison result between the zoom scaling factor and the predetermined scaling factor to generate the digital zoom images comprises:
converting the digital zoom images into YUV format using an image signal processor when the zoom scaling factor is greater than 1 and less than the predetermined scaling factor.

9. The zooming photography method according to claim 5, wherein the step of synthesizing the digital zoom images to generate the final photographed image comprises:
synthesizing the digital zoom images through the hardware abstraction layer when the zoom scaling factor is greater than 1 and less than the predetermined scaling factor to generate the final photographed image; and
synthesizing the digital zoom images through the camera application when the zoom scaling factor is greater than or equal to the predetermined scaling factor to generate the final photographed image.

10. An electronic device, comprising:
an image sensor; and
a processor coupled to the image sensor and configured to:
control the image sensor to generate a plurality of first preview images according to a zoom scaling factor during a period of operating in a preview mode;
copy the first preview images to a buffer;
extract a plurality of second preview images from the first preview images in the buffer when receiving a photographing command; and
generate a final photographed image conforming to an image storage format according to the second preview images based on the zoom scaling factor.
